(19) United States
(12) Patent Application Publication
(10) Pub. No.: US 2012/0074074 A1
(43) Pub. Date: Mar. 29, 2012

(54) SELF-CLEANING SCREEN SYSTEM AND METHOD

(75) Inventors: Meng H. Lean, Santa Clara, CA (US); Armin R. Völkel, Mountain View, CA (US); Ashutosh Kole, San Francisco, CA (US); Kai Melde, San Francisco, CA (US); Huangpin Ben Hsieh, Palo Alto, CA (US)

(73) Assignee: Palo Alto Research Center Incorporated, Palo Alto, CA (US)

(21) Appl. No.: 12/889,495

(22) Filed: Sep. 24, 2010

(51) Int. Cl. B01D 29/62; B01D 29/66; B01D 29/64; B01D 33/44

(52) U.S. Cl. 210/798; 210/354; 210/355; 210/791

(57) ABSTRACT

A self-cleaning screen system and method removes contaminants from a fluid passed through a screen of the self-cleaning screen system. The self-cleaning screen system includes a cleaning mechanism used to remove contaminants which may have adhered to the screen. The self-cleaning screen system is self-powered by extracting energy from the fluid flow to cause rotation or other movement of either the screen and/or the cleaning mechanism.

### BACKGROUND

The embodiments described herein relate generally to a self-cleaning screen system and method for removal of contaminants from a fluid passed through a screen. The method finds particular application in water purification systems, although it will be appreciated that selected aspects may find application in related areas encountering issues of extracting contaminants from fluids.

Current methods of removal of suspended particulates in a flow stream involve several stages of separation with mechanisms that include combinations of flotation, centrifugation, filtration, and sedimentation. Depending on source water and requested output water quality, filtration based process trains require one or more filtration steps with decreasing pore size to sequentially remove particles in a particular size range. Hardware embodiments range from coarse baffles and mesh screens at intake, to media filters, and finally to membranes for polishing. One drawback to most screen filters is that they clog rapidly requiring frequent backwash and manual cleaning. This results in increased labor, chemical, energy and replacement costs.

Self-cleaning screen filters are well known. U.S. Pat. No. 1,591,821 discloses the use of water as a backwashing fluid. U.S. Pat. No. 4,702,847 and U.S. Pat. No. 5,409,618 discloses self-cleaning filters where the water backwash is accompanied by a suction device that removes the build-up debris directly. U.S. Pat. No. 7,055,699 discloses a self-cleaning filter wherein the water backwash is accomplished through ultrasound. U.S. Pat. No. 4,961,864 discloses a cleaning device which rests against the upwards facing surface of a screen grid and moves the screenings during movement of the cleaning device horizontally towards the edge regions to cause the screenings to pass onto transport surfaces situated adjacent to edge regions. U.S. Pat. No. 5,332,499 discloses a self-cleaning filter suitable for removing solid particles having a size not less than a predetermined size and includes a casing, a tubular filter screen disposed in the casing, first and second cleaning blades, and a device for rotating the tubular filter screen. U.S. Pat. No. 5,192,429 discloses a self-propelled cleaning device including water jets that are directed onto properly arranged paddles that cause the frame with the screen to move past jets that provide the cleaning fluid. None disclose a self-propelled cleaning mechanism that combines a screen filter, a cleaning blade and a turbine.

Thus, it is desirable to establish a self-cleaning screen system that extracts or collects energy from its own operation and then uses that collected energy to generate the energy/power needed for cleaning the screen.

### BRIEF DESCRIPTION

In accordance with one embodiment described herein, there is provided a self-cleaning screen system which removes contaminants from a fluid passed through a screen of the self-cleaning screen system. The self-cleaning screen system includes a cleaning mechanism used to remove contaminants which may have adhered to the screen. The self-cleaning screen system is self-powered by extracting energy from the fluid flow to cause rotation or other movement of either the screen and/or the cleaning mechanism.

### BRIEF DESCRIPTION OF THE DRAWINGS

FIGS. 1A-1D illustrate a self-cleaning screen system in accordance with an embodiment;

FIGS. 2A-2D illustrate a self-cleaning screen system in accordance with another embodiment using an angled knife-edge wiper/scraper and a hooded section;

FIGS. 3A-3B illustrate a self-cleaning screen system in accordance with another embodiment using a knife-edge blade;

FIG. 4 illustrates a self-cleaning screen system in accordance with another embodiment using a corrugated screen;

FIG. 5 illustrates a self-cleaning screen system in accordance with another embodiment using a brush cleaning mechanism;

FIG. 6 illustrates a self-cleaning screen system in accordance with another embodiment using an agitating mechanism;

FIG. 7 illustrates a self-cleaning screen system in accordance with another embodiment using a knife-edge blade attached to a stationary shaft;

FIG. 8 illustrates a self-cleaning screen system in accordance with another embodiment including a gear-based cleaning mechanism;

FIGS. 9A-9D illustrate a self-cleaning screen system in accordance with another embodiment having the screen centrally located within a conduit and outside a tank;

FIGS. 10A-10B illustrate a self-cleaning screen system in accordance with another embodiment using pressurized air;

FIGS. 11A-11B illustrate a self-cleaning screen system in accordance with another embodiment using mechanical means;

FIG. 12 depicts a propeller turbine as an example for use in the above embodiments;

FIG. 13 is a graph illustrating available power for different flow rates and pressures;

FIG. 14A-14B are graphs illustrating power requirements for a cleaning system that generates turbulence near the screen surface; and

FIG. 15 is a graph illustrating power requirements for a cleaning system using scraping blades.

### DETAILED DESCRIPTION

Embodiments herein provide variations of a self-cleaning screen system and method for the removal of contaminants from a fluid flow using a screen positioned in the fluid flow to retain contaminants, and a self-powered or self-powering cleaning mechanism to remove the contaminants from the screen. The cleaning mechanisms use turbine powered motion, and include: a flow-driven screen rotating against stationary turbine blades, flow-driven turbine blades rotating against a stationary screen; variations in screen, additional cleaning blades, and a turbine blade design; and directional flow control of fluid and gas for back-flush. Generators to store mechanical and/or electrical energy to power the back flush cleaning functions are also included. Faster flow or higher flow rates result in increased rotation speed and hence increased rates of sediment removal from the screen. In some embodiments, clogging materials are allowed to sediment and are diverted to waste outlets for removal and/or collection.

The term “self-powered” and/or “self-powering” as used herein refers to the use of the energy from fluid flow occurring within the system to either prevent or reduce the build-up of particulate matter at or inside the screen/mesh. This is accomplished by the activation of the screen and/or the cleaning mechanism, where activation includes causing a rotational movement. Therefore, no external power source is required, making the system and method, and all variations thereof, self-powered and/or self-powering. The term “screen” as is used herein, refers to a mechanism that allows fluid to pass through but prevents the passage of debris or particulate matter, entrained in the fluid. The terms “activate” and “activation” are used herein to refer to causing at least one of the screen or the cleaning mechanism to rotate or move relative to the other, i.e. the screen and/or the cleaning mechanism.

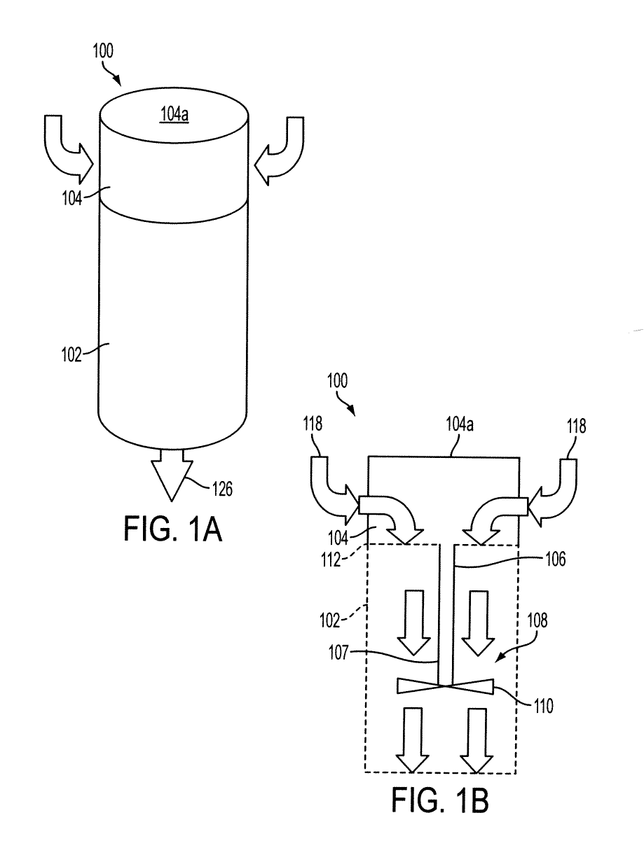

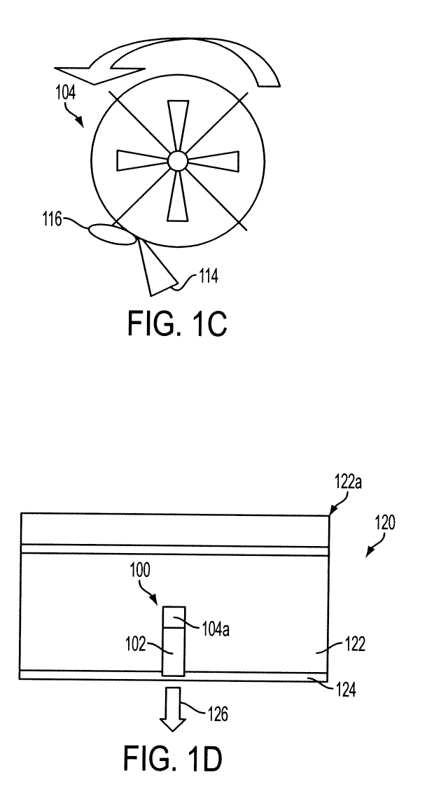

Referring to the drawings, FIGS. 1A-1D illustrate a first embodiment of a self-cleaning screen system 100 positioned on top of a conduit 102 for removal of contaminants from a fluid passed through a screen 104. As shown in the perspective view of FIG. 1A, system 100 includes a screen 104 positioned on top of conduit 102. The term “conduit” is used herein to refer to any mechanism allowing a flow of fluid to pass through the mechanism from one end to the other. Such mechanisms may include a pipe, a hollow cylinder, or other substantially hollow structure, and may be round, square, rectangular or any other suitable configuration.

Turning to the side view of FIG. 1B a more detailed depiction of a self-cleaning screen system 100 is provided. In particular, system 100 is intended to show screen 104 operatively connected to one end (a first end) of a shaft 106 while the other end (a second end) of shaft 107 carries a turbine head 108 having a plurality of angled turbine blades 110. The connection of screen 104 to shaft 106 is accomplished by any known connection arrangement including welding or bolting the upper end of shaft 106 to a portion of screen 104, such as an upper surface 104a (shown in FIG. 1B) or other location of screen 104. The assembled self-cleaning screen system 100 is allowed to freely rotate about the conduit by use of a connector 112, such as a slip ring, a sleeve or other appropriate component that permits rotation of the screen. The connector is mounted to a wall or other appropriate location of conduit 102.

In this embodiment, self-cleaning screen system 100 may include having screen 104 rotating against or in close relationship to a stationary wiper blade or scraper 114, shown more clearly in FIG. 1C. This arrangement acts to remove debris (e.g., hair, fiber, lint, etc.) 116 from the exterior surface of screen 104 as it rotates. In this embodiment the wiper blade or scraper has a knife edged design, although other shapes and types of wipers/scrapers may be used. Further, wiper blades/scrapers may include other surface cleaning mechanisms that perform this same function, including, for example, wires.

With continued attention to FIGS. 1A-1D operation of a self-cleaning screen system 100 is understood as follows. Fluid 118 enters through screen 104, flows down conduit 102, and drives turbine blades 110, which in turn rotate shaft 106, which in turn causes screen 104 to rotate. In one embodiment, the screen 104 is positioned at the entrance of the conduit 102 so that the fluid passes through the screen before driving the turbine blades 110. Stationary wiper blade 114 scrapes debris 116 that is trapped on the screen surface, allowing the debris to sediment. The assembled self-cleaning screen system 100 thus operates in the self-powered manner as previously described, as the energy used to perform the cleaning is generated by the fluid flow past the turbine blades 110. This operation has the additional feature of increasing rotation speed as flow rate increases.

With more particular attention to FIG. 1D (and continued attention to FIGS. 1A-1C), a self-cleaning screen system 100 is positioned on top of conduit 102 submerged in a tank 120 filled with fluid 122 such as raw water. The self-cleaning screen system 100 is positioned on conduit 102 such that system 100 is elevated from sedimentation or sediment bed 124. The pressure head in tank 120 drives the fluid through screen 104 down the inside of conduit 102, where it gives up its energy driving turbine blades 110 causing screen 104 to rotate. The rotational speed is directly proportional to the fluid flow rate. An increased turbine speed causes screen 104 to be cleaned more rapidly, which helps to counteract the increased particle build-up near the mesh due to the increased flow rate. As an alternative to driving the fluid using the pressure head of a filled tank, the fluid can be driven through the screen by a pump or by gravity driven flow.

The hydrostatic pressure from the top of fluid 122a to the top of screen 104a is sufficient to overcome a small pressure drop that may occur when the working fluid crosses screen 104. The stationary wiper/scraper 114 removes debris or particulates 116 that may be trapped on screen 104, allowing them to settle in sediment bed 124 at the bottom of tank 120. Processed water 126 exits from tank 120 as shown. Waste outlets (not shown) may be located below sediment bed 124 to substantially draw the sedimentation from the sediment bed 124 for disposal. In this embodiment, proper seals need to be in place to allow the free rotation of the screen 104 against the static exit conduit 102 without allowing unfiltered fluid to by-pass the screen. In one embodiment, pressure is maintained in a tank 120 by continually filling tank 120 with fluid 122. In another embodiment, pressure is maintained in tank 120 by a pump (not shown) located outside the tank.

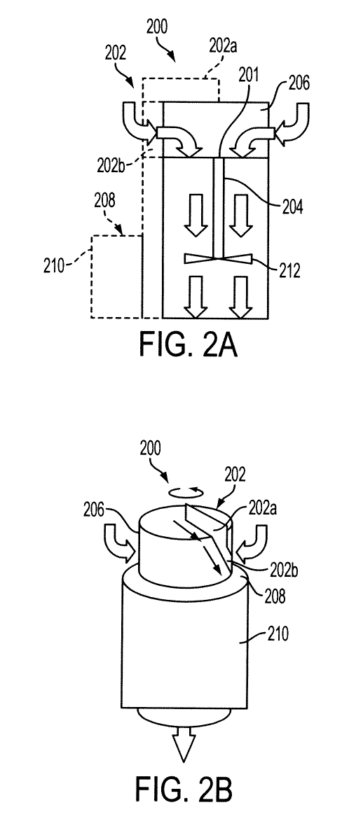

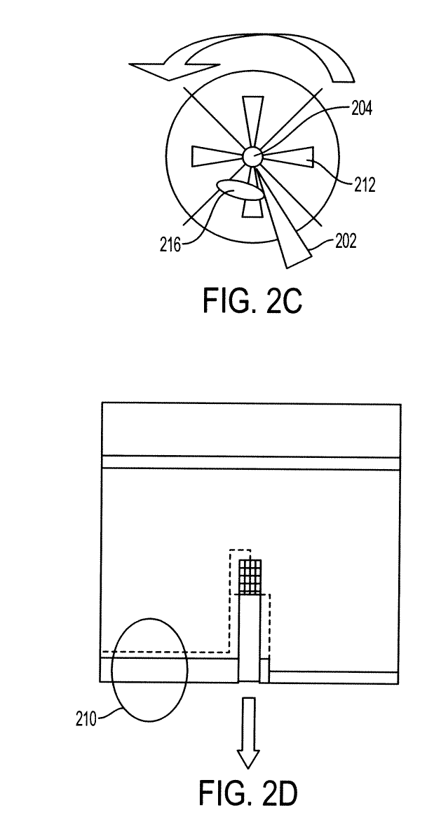

Referring to the drawings, FIGS. 2A-2D illustrate another self-cleaning screen system 200 for removal of contaminants from a fluid passed through a screen. This embodiment is similar to the one shown in FIGS. 1A-1D, but with an angled knife-edge wiper/scraper structure 202 that is attached rigidly to top plate 201 at a first end 204 as in previous embodiments. This structure 202 then extends horizontally 202a to cover the external horizontal area of screen 206 and extends in an angled vertical direction 202b to cover the external vertical area of screen 206. The angled knife-edge wiper/scraper structure 202 is directing the particulates that have been removed from the screen 206 downward towards an opening 208 in a hooded section 210 at the bottom of a raw water tank for discharge, shown more clearly in FIG. 2D. The hydrostatic pressure drives turbine blades 212, which in turn drive the screen 206. In an embodiment, debris 216 can be directed away into a storage area (not shown).

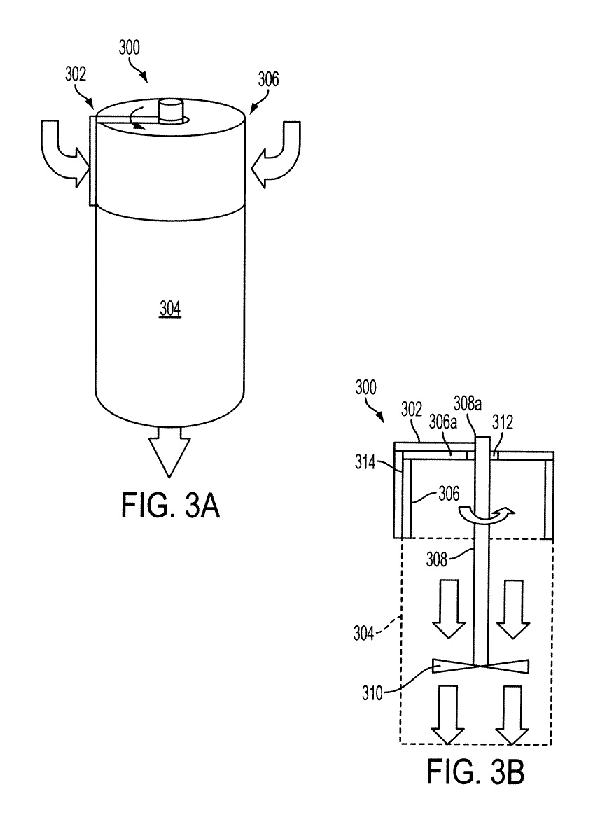

Referring to FIGS. 3A-3B illustrated is a next embodiment of a self-cleaning screen system 300 for removal of debris or contaminants from a fluid passed through a screen. As shown by the perspective view of FIG. 3A and the side-view of FIG. 3B a wiping/scraping arrangement 302 is located externally of conduit 304 and screen 306. The screen 306 being fixedly attached to conduit 304, whereby the screen does not rotate relative to the conduit. The conduit 304 encompasses a shaft 308 having rotating turbine blades 310 attached to one end, while the other end of the shaft intersects an upper surface 306a of screen 306, and is held rotatably in place, for example, by a bearing system 312. In this embodiment, wiping/scraping arrangement 302 includes a knife-edge wiping/scraping element 314 attached rigidly to an end 308a of shaft 308 and extends to cover the horizontal and vertical exterior surfaces of screen 306. When in motion, wiping/scraping element 314 is in contact or is sufficiently close to the exterior surface to clean the entire exterior surface area of screen 306 in one rotation.

The hydrostatic pressure drives the plurality of turbine blades 310, which in turn drives wiper/scraper element 314 around the outside of screen 306. The rotation per minute (rpm) of wiper/scraper element 314 is substantially the same as that of turbine blades 310. The relative motion between stationary screen 306 and wiper/scraper element 314 will cause a cleaning action over the screen, removing the debris collected on the screen. This design has a low mass of moving parts, a small surface area that may use a movable fluidic seal, and maximizes the surface area of the screen available for filtering of the fluid.

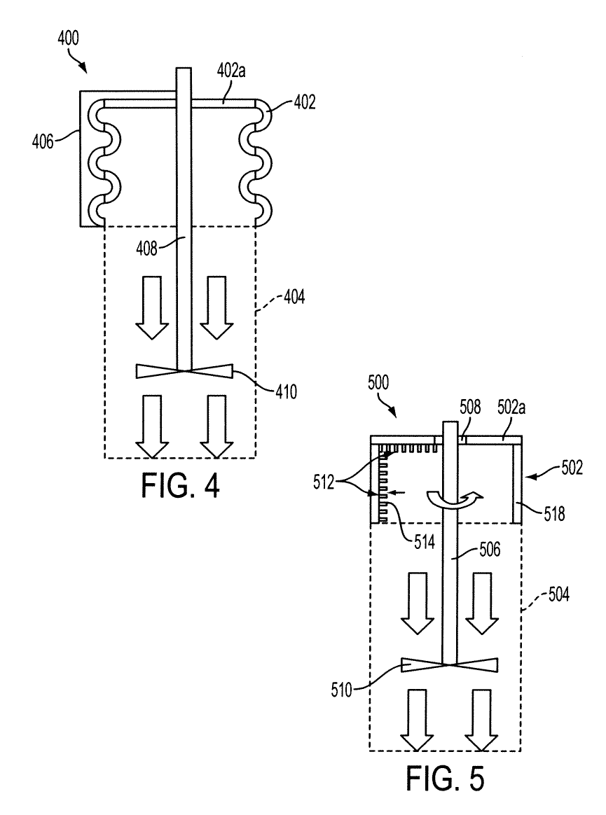

Referring to the drawings, FIG. 4 illustrates a further embodiment of a self-cleaning screen system 400 for removal of contaminants from a fluid passed through a screen. This embodiment is similar to the system of FIG. 3, where mesh screen 402 is rigidly attached to conduit 404, wiper/scraper element 406 is rigidly attached to shaft 408 at one end and at the other end the shaft carries turbine propeller blades 410. The upper end of shaft 408 is also rotatably connected through a screen upper surface 402a by a bearing arrangement (not shown). A particular aspect of this embodiment is that screen 402 is a corrugated screen and therefore the wiping/scraper element 406 is formed to follow the corrugated pattern of the screen.

The corrugated screen design allows for a larger filtering surface on screen 402 and an increased filter rate through screen 402. The corrugations of the screen run concentric to the axis of rotation of shaft 408. The surface of wiper/scraper element 406 is formed to substantially match the pattern of the screen 402 to ensure that all surfaces of screen 402 are cleaned. Although, it may be appreciated the configurations of the corrugations could be varied, the cleaning blades/wires would need to change shape in order to clean the rotating screen.

The corrugated screen may include corrugated patterns. In one embodiment, the corrugated patterns are located on a vertical surface of the screen. In another embodiment, the corrugated patterns are located on a horizontal surface of the screen. In yet another embodiment, the corrugated patterns are located on a vertical surface and a horizontal surface of the screen.

Referring to the drawings, FIG. 5 illustrates still another self-cleaning screen system 500 for removal of contaminants from a fluid passed through a screen. Similar to the structure of FIG. 3, screen 502 and conduit 504 are rigidly attached to one another. Shaft 506 is at one end rotatably attached through an upper surface of the screen 502a by a bearing arrangement 508 and at a second end the shaft carries turbine blades 510. However, distinct from FIG. 3, a brush-like structure 512 located on the internal side of the screen 502 is attached rigidly to shaft 506 in a manner to cover the internal horizontal and vertical surfaces of screen 502. Brush like structure 512 is similar to the knife edge wiper/scraper of FIG. 3. However, this element is comprised of bristles and is placed on the interior of the mesh screen. When in motion, the brush-like structure 512 cleans the entire interior surface area of screen 502 in one rotation.

The hydrostatic pressure drives turbine blades 510, which in turn drives brush-like structure 512 around the interior of screen 502. In one embodiment bristles 514 of brush-like structure 512 are preloaded, i.e. a spring mechanism pushes the bristles 514 of brush-like structure 512 against the pores or holes 518 in the screen. When brush-like structure 512 rotates, bristles 514 push the debris caught in the pores or holes 518 of screen 502, by angularly entering the pores in the screen. This pushes the debris towards the outside or back into the main tank (not shown) which holds the waste water, thus stopping debris from coming into conduit 504.

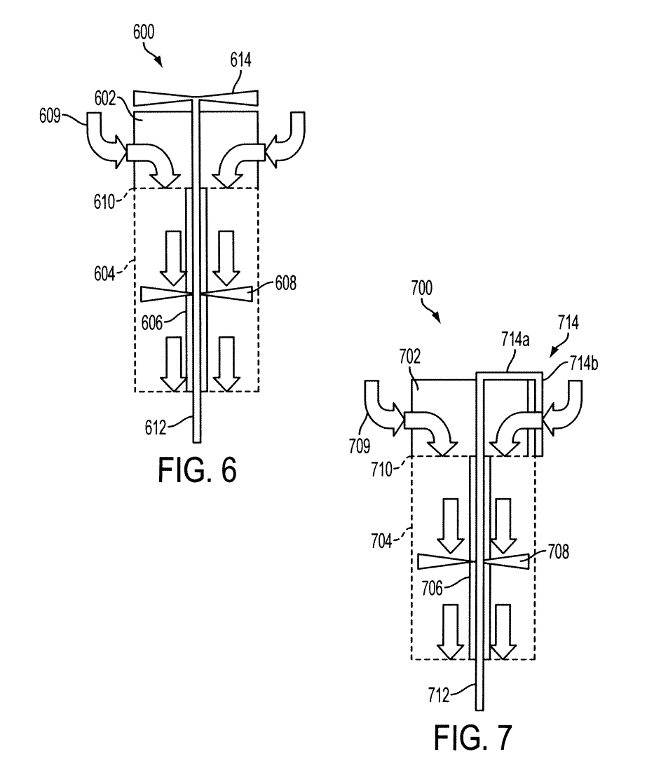

Referring to the drawings, FIGS. 6, 7, and 8 illustrate side views of additional self-cleaning screen systems 600, 700 and 800 for removal of contaminants from a fluid passed through a screen. Similar to at least some previous embodiment's screens 602, 702, 802 are rotatably positioned on top of respective conduits 604, 704, 804. Rotatable shafts 606, 706, 806 are provided with turbine blades 608, 708, 808, positioned to rotate in response to fluid 609, 709, 809 flowing through each system. As in previous embodiments upper ends of rotatable shafts 606, 706, 806 are fixedly attached to screens 602, 702, 802 such that as the shafts rotate the screens are also caused to rotate. To achieve this rotation, conduits 604, 704, 804 have a slip ring, sleeve or other component 610, 710, 810 which permits this movement, as in previous embodiments. From the above it may be appreciated various aspects of these embodiments are similar in configuration and operation to systems shown in previous embodiments.

The following will focus on aspects of systems 600, 700, 800 which are different from the previous embodiments. In particular rotatable shafts 606, 706, 806 of each respective embodiment have through their interior corresponding inner shafts 612, 712, 812, which have associated attached cleaning mechanisms 614, 714, 814.

In FIG. 6, the cleaning mechanism 614 is an agitation mechanism that is stationary and aids in generating a vortex of water when submerged in a raw water tank (not shown). This design enhances agitation and minimizes debris accumulation when screen 602 is rotated. Self-cleaning screen system 600 is substantially symmetrical and, therefore, the disturbance to screen rotation is minimized.

In FIG. 7 stationary cleaning mechanism 714 is attached to stationary inner shaft 712. The stationary cleaning mechanism, which may be, for example, wiper/scraper blades or brushes, is designed with an extended horizontal section 714a and an extended vertical section 714b in order to clean the corresponding horizontal and vertical portions of screen 702 as the screen is rotated.

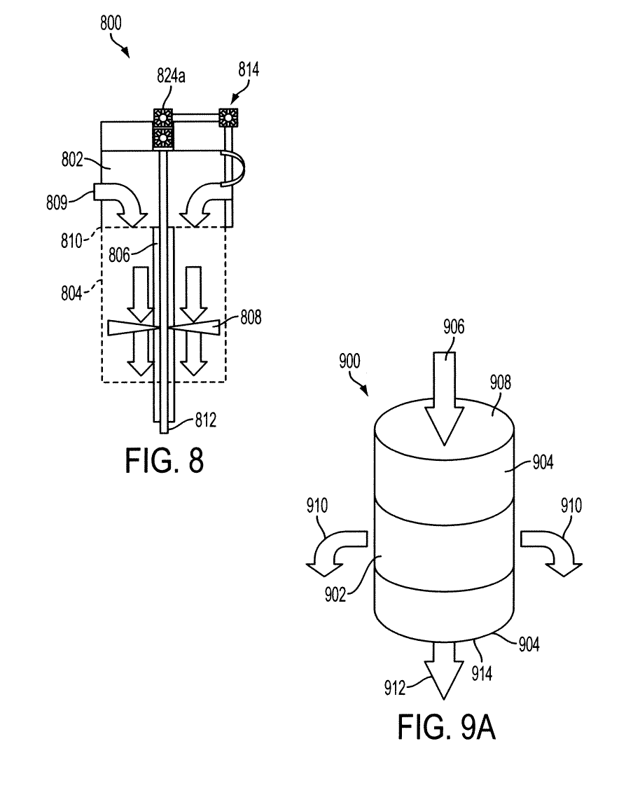

In FIG. 8 cleaning mechanism 814, is a rotating cleaning mechanism that is attached to rotating inner shaft 812 to clean the horizontal and vertical outward portions of screen 802. The rotating inner shaft 812 is connected to and rotated with outer shaft 806, and both are powered by fluid flow 809 through the self-cleaning screen system 800. Rotating cleaning mechanism 814 is made to rotate in a direction opposite the rotation of screen 802 by gearing arrangement 824a. By this design the rotating screen and rotating cleaning mechanism rotate in opposite directions to clean the surface.

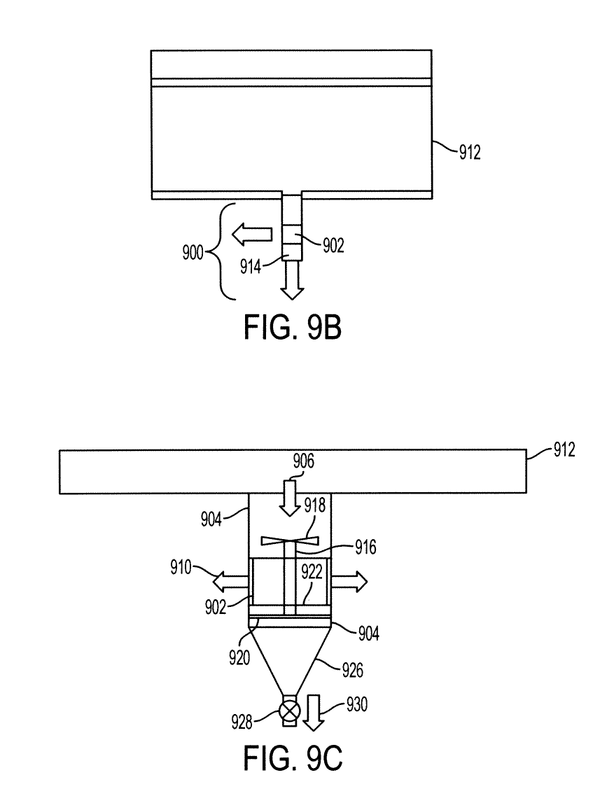

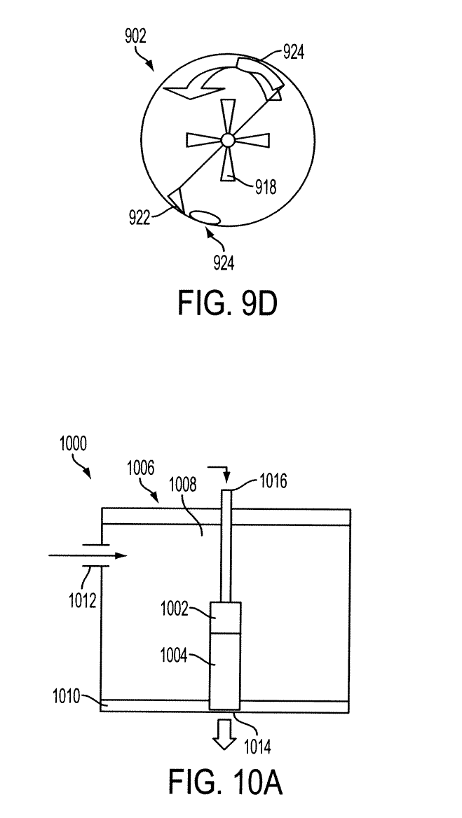

Referring now to FIGS. 9A-9D illustrated is another embodiment of a self-cleaning screen system 900 for removal of debris or contaminants from a fluid passed through a screen. In this embodiment, the perspective view of FIG. 9A shows screen 902 positioned within conduit 904. While it is shown to be positioned in the middle of the length of conduit 904, it may be positioned anywhere along the length to better achieve its purpose in a particular system. In this embodiment fluid 906 enters through an opening 908 of conduit 904, cleaned fluid (such as water) 910 exits from screen 902 and sludge and debris collects at the bottom 914 and is periodically removed through conduit 904.

Side view of FIG. 9B, shows self-cleaning screen system 900 positioned outside and below fluid tank 912 as opposed to the configuration shown in FIG. 1D.

The side view of FIG. 9C and top view of FIG. 9D depict the structure of this embodiment in greater detail. Inside conduit 904 self-cleaning screen system 900 includes a shaft 916 with propeller blades 918 attached at an upper end of the shaft. The opposite end of the shaft is rotatably connected to a support member 920, which itself is fixedly connected across the interior of conduit 904. Propeller blades 918 operate a set of one or more wiper/scraper blades 922 that are connected to rotating shaft 916 and act to continuously scrape debris 924 from screen mesh 902. At the bottom end of conduit 904 is a normally closed valve arrangement 928. Debris 924 collects and is removed as sludge through valve 928 in the direction of 930. The bottom end of the conduit is shaped such as to help the sludge go through the exit valve 928. One such an embodiment is the funnel 926 as shown in FIG. 9C. In one design of this embodiment wiper/scraper blades may be in the form of wires. Also, in some cases the wiper/scraper comes into contact with the surface of the screen, in other embodiments the wipers/scrapers may actually not contact the surface of the screen but are used to create turbulence in the fluid which is used to remove the debris.

In this embodiment, fluid flow 906 encounters propeller blades 918 prior to passing through screen 902. Also, the wipers/scrappers are on the same side as the fluid flow 906 thus eliminating the need for sealing these components from the stationary parts of the self-cleaning screen system and eliminating energy losses due to friction against the sealant. In this arrangement the rotating surfaces, which are comprised of the turbine blades 918 and the shaft 916, are in contact with the fluid (e.g., water) moving through conduit 904, but not with the fluid in the raw water tank 912. It also has a well-defined sludge removal process.

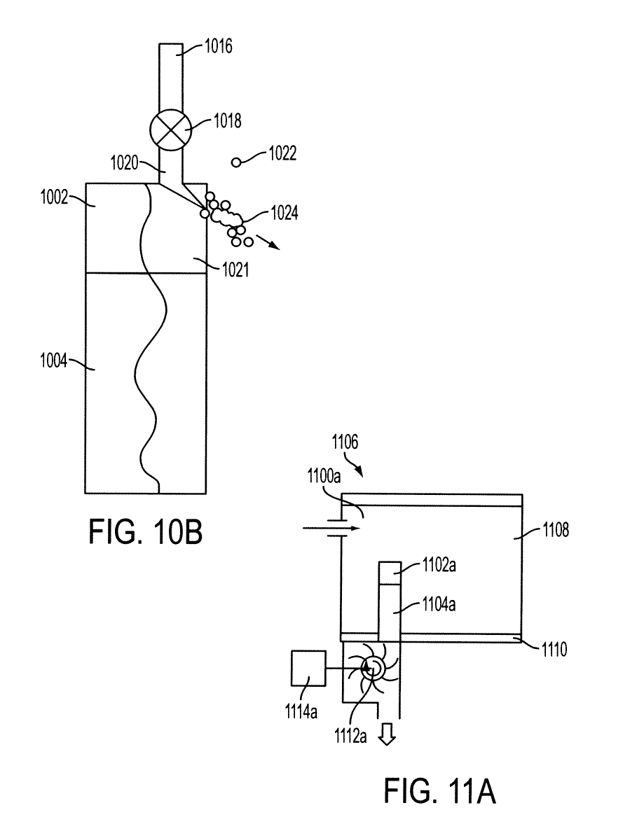

Referring to the drawings, FIGS. 10A-10B illustrate a self-cleaning screen system 1000 for removal of contaminants from a fluid passed through a screen. This embodiment is for a situation where the self-cleaning screen system is submerged in a tank.

FIG. 10A shows screen 1002 positioned on top of conduit 1004, submerged in a raw water tank 1006 filled with fluid 1008. Screen 1002 is positioned on conduit 1004 such that it is elevated from sedimentation or a sediment bed 1010. Input 1012 is a source of raw fluid into the sealed tank 1006. Cleaned fluid exits tank 1006 via outlet 1014. A pipe 1016 to deliver air extends through sealed tank 1006 to self-cleaning screen system 1000.

With continuing attention to FIG. 10A and also now FIG. 10B, providing a cut-away view of the device, pipe structure 1016 enables ambient air flow through a check valve 1018 and a nozzle 1020 to a clean region 1021 behind or within screen 1002. Gravity or suction driven flow to the outlet 1014, will lead to a pressure drop in tank 1006 (shown in FIG. 10A) that opens check valve 1018 when the pressure drop across screen 1002 rises above the check valve cracking pressure. Check valve cracking pressure is the minimum upstream pressure at which the valve will operate. The check valve has been pre-loaded to open at a predetermined cracking pressure. Nozzle 1020 directs and accelerates incoming air through screen 1002 in the opposite direction to the liquid/water flow. The movement of air bubbles 1022 removes debris 1024 from the screen 1002 and supports agitation by the upwards oriented motion of the bubbles in tank 1006. A rotating screen 1002 (as accomplished for example in previous embodiments) ensures cleaning of the whole screen area. In another embodiment, a rotating nozzle can be used and the screen is then held stationary. In yet another embodiment, multiple evenly arranged nozzles can be used. Regulation of liquid level in the tank and check valve cracking pressure are used to balance the cleaning cycle against the allowed pressure drop across screen 1002.

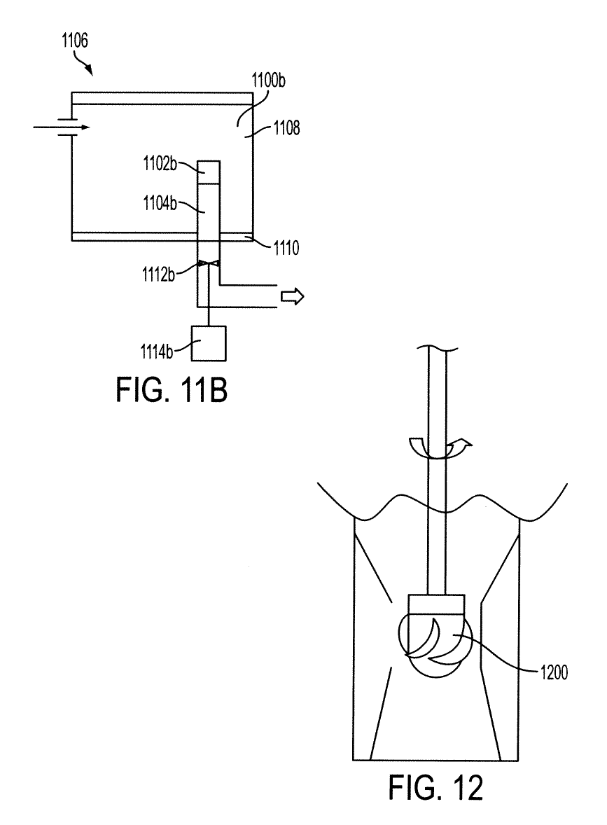

Referring to the drawings, FIGS. 11A and 11B illustrate alternative self-cleaning screen systems 1100a and 1100b for removal of contaminants from a fluid passed through a screen. FIGS. 11A and 11B show two screens 1102a and 1102b positioned on top of respective conduits 1104a and 1104b. The screens and the conduits are submerged in a raw water tank 1106 filled with fluid 1108, where the screens are elevated from sedimentation or a sediment bed 1110 by their position on the conduits. The self-cleaning screen systems 1100a and 1100b employ alternative arrangements to regain energy from fluid motion for cleaning purposes. System 1100a uses a paddle wheel 1112a and energy storage system 1114a and system 1100b uses a propeller 1112b and energy storage system 1114b. The rotational energy from the paddle wheel or the propeller is transmitted to each respective energy storage system (e.g., the energy could be used to run a fly wheel, charge a battery, load a spring or store energy in some other way). The stored energy will, at certain intervals, drive the rotating actuator (e.g., paddle wheel, propellers, etc.) backwards to achieve a short and fast fluid backflow to clean the respective screen. In one embodiment, a mechanical switch with a strong hysteresis triggers this backflow if the rotation speed of the main actuator falls below a certain level. In another embodiment, the rotational energy is converted to electrical energy by a dynamo and used to charge a battery allowing for using low power electrical circuits to trigger cleaning cycles.

Turning to FIG. 12 depicted is a turbine blade arrangement 1200 that can be used as a driver in embodiments which employ a turbine action. This turbine propeller arrangement works with low hydrostatic head. The turbine blades are attached to the shaft in such a way that as the fluid (e.g., water) is directed to the turbine head and exits, it exerts force on the turbine blades making them rotate about the axis causing the propeller shaft (attached to the turbine head) to rotate. The fluid (e.g., water) has to be directed towards the turbine head in a way so as to cause maximum work transfer from the hydrostatic water head to the turbine.

It is to be understood the turbine head described in this figure, as well as the turbine blades, air flow, paddle wheel and gear boxes, and other previously described mechanisms are specific embodiments of energy transforming or transformer devices and systems. Thus, using any of the foregoing mechanisms, or mechanisms similar thereto, the described systems are configured to extract potential and/or kinetic energy from the fluid flow and to use the extracted energy to rotate at least one of the screen or the cleaning mechanism of the various self-cleaning screen systems. This shows that the energy used to clean the screen is obtained from the system itself and not from an external source. Implementation of the described systems eliminates entirely or increases the time between which it is necessary to stop fluid filtration operations to allow for cleaning of the screens. It is understood the maximum power which is available for operation of the described self-cleaning screen systems is the flow rate times the pressure head. It is also to be appreciated not all energy will be converted, as losses will exist due to internal friction (such as will exist in systems that employ the turbine blades) and also due to incomplete use of the pressure head.

The power P that can be extracted from the flowing water is given by

P=ηpQ,

where p is the pressure of the incoming fluid, Q the flow rate, and η the efficiency of the turbine to convert the energy from the water into rotational motion of the cleaning mechanism. The pressure can be provided either by a pump, or the water column of a reservoir wherein the pressure by a water column of a reservoir is directly related to the height h of the water column as

p=dgh,

where d is the density of the fluid and g=9.81 m/s² is the gravitational acceleration.

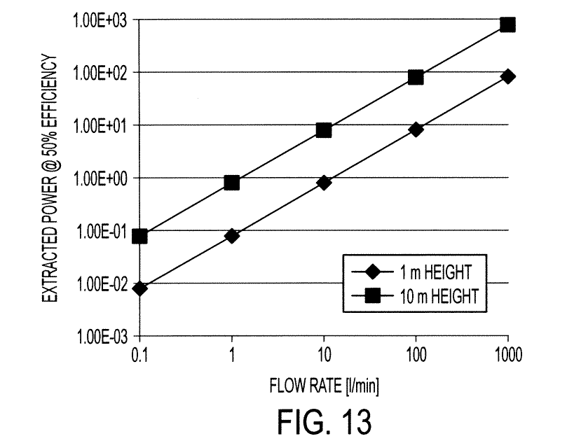

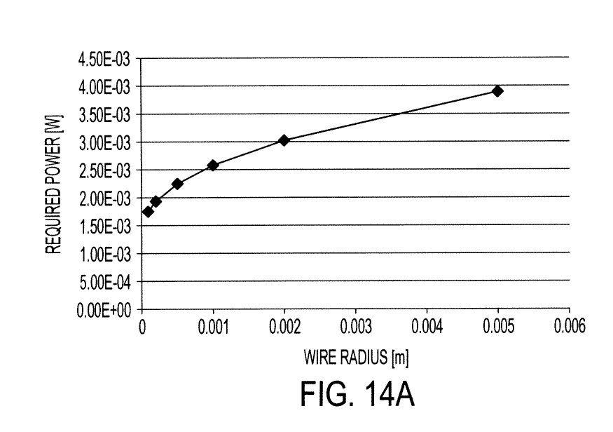

FIG. 13 is a plot of flow rate versus extracted power. FIG. 13 illustrates available power for different flow rates at two pressures equivalent to 1 and 10 m reservoir height, and with a turbine efficiency η=50%, which is a conservative estimate given that Kaplan turbines, which are inward flow reaction turbines, i.e. the working fluid changes pressure as it moves through the turbine giving up its energy, can be built to have efficiencies over 90%. Even at moderate flow rates of 10 to 100 liters per minute tens to hundreds of Watts of mechanical power are available. For a cleaning system that generates turbulence near the screen surface the power requirements are dominated by the drag of the fluid on the moving parts. In the case of a set of wires moving close by the screen, the power depends on the diameter and length of the wire, the number of wires, the rotational speed of the cleaning mechanism, the viscosity of the fluid, and on the distance of the wires from the screen. FIG. 13 clearly shows that an increase in reservoir height and flow rate yields an increase in available power to drive the system.

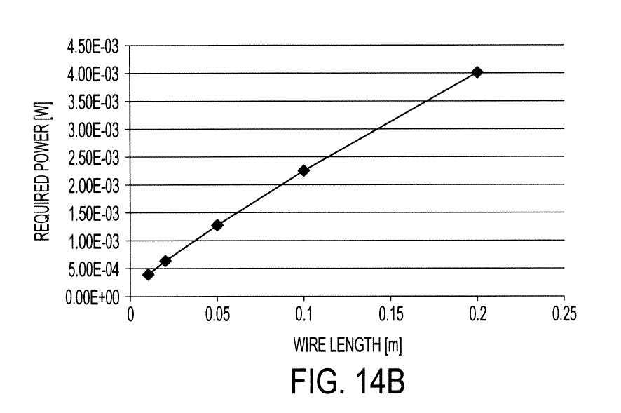

FIGS. 14A and 14B show required power estimates for a system having 10 wires rotating at 1 Hz through water as a function of wire radius (FIG. 14A) and wire length (FIG. 14B). As can be seen, an increase in wire radius or wire length increases frictional surface area requiring a corresponding increase in the power needed to drive the system.

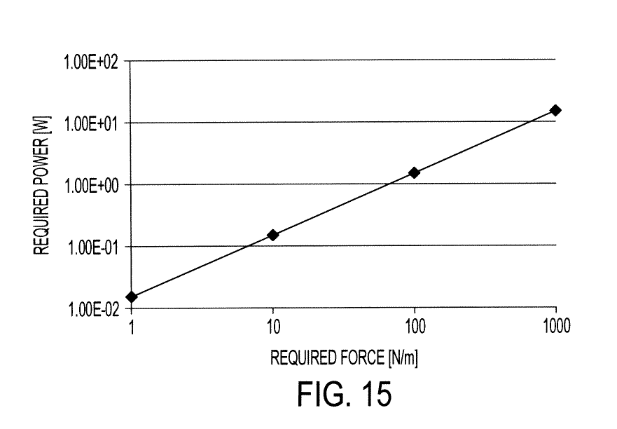

FIG. 15 is a plot of required force versus required power. FIG. 15 illustrates typical power requirements for a 0.1 m long cleaning blade rotating at 1 Hz (Hertz). For a cleaning system that uses scraper blades the power requirements are dominated by the friction of the blades against the screen. In particular, the power depends on the length and number of blades, their rotational speed, the normal force per unit length acting on the blades, and the friction coefficient between the blades and the screen surface. FIG. 15 shows how an increase in required force requires an increase in required power.

The foregoing embodiments provide variations of a self-cleaning screen system and method for the removal of contaminants from a fluid flow using a screen positioned in the fluid flow to retain contaminants, and a cleaning mechanism to remove the contaminants from the screen. The cleaning mechanisms use turbine powered motion, and include: a flow-driven screen rotation against a stationary wiper blade; a stationary screen with a flow driven rotating wiper blade; variations in screen, cleaning blade, and turbine blade design; and directional flow control of fluid and gas for back-flush. Generators to store mechanical and/or electrical energy to power the back flush cleaning functions are also included. Faster flow or higher flow rates result in increased rotation speed and hence increased rates of sediment removal from the screen. In some embodiments, clogging materials are allowed to sediment and are diverted to waste outlets for removal and/or collection. The screens may provide openings of different sizes, for example in one embodiment the screen may be an “80 mesh” with 250 micron holes. The described systems may be sized for a variety of flow rates, including but not limited to 1-100 liters per minute.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A self-cleaning screen system for removal of contaminants from a fluid passed through a screen comprising:
a conduit having a fluid entrance and a fluid exit separate from the fluid entrance;
a screen positioned in relationship to the conduit such that contaminants in fluid passing through the conduit are removed as the fluid passes through the screen.
a cleaning mechanism operatively associated with the screen to remove the contaminants; and
an energy transformer configured to extract energy from the fluid flow and to use the extracted energy to activate at least one of the screen or the cleaning mechanism.

2. The system of claim 1, wherein the activation is a rotation caused by a turbine motion, a back flush using pressurized directed air flow, a back flush using stored energy, or combinations thereof.

3. The system of claim 1, wherein the screen is affixed to a shaft, the shaft being operatively associated at a second end with a turbine head and a plurality of turbine blades attached to the head, wherein the turbine head is affixed downstream of the screen.

4. The system of claim 1, wherein the screen is positioned in at least one of the following:
i. the fluid entrance of the conduit so that the fluid passes through the screen before operating the cleaning mechanism; or
ii. the fluid exit of the conduit so that the fluid is operating the cleaning mechanism before passing through the screen.

5. The system of claim 1, wherein the screen is positioned in at least one of the following:
i. on top of the conduit to elevate the screen from a sediment bed; or
ii. within the conduit to extend the screen below a sediment bed.

6. The system of claim 3, wherein the cleaning mechanism is at least one of:
i. the screen rotating against or in operational relationship to the stationary turbine blades,
ii. the turbine blades rotating against or in operational relationship to a stationary screen,
iii. the turbine blades and the turbine motion positioned on the same side of the screen, and
iv. the turbine blades and the turbine motion positioned on opposite sides of the screen.

7. The system of claim 3, wherein a first end of the shaft is associated with at least one of:
i. a knife-edge structure positioned to remove contaminants from at least one of a horizontal and vertical outward portion of the screen;
ii. a plurality of turbine blades positioned above a horizontal outward portion of the screen; and
iii. a brush-like structure positioned to remove contaminants from at least one of a horizontal and vertical inward or outward portion of the screen.

8. The system of claim 1, wherein the energy transformer includes turbine propeller blades attached to an end of a rotating shaft.

9. The system of claim 1, wherein the screen is a corrugated screen comprising corrugated patterns located on:
i. a vertical surface of the screen;
ii. a horizontal surface of the screen; and
iii. a vertical surface and a horizontal surface of the screen.

10. A method for removal of contaminants from a fluid passed through a self-cleaning screen comprising:
providing a fluid flow passing through a conduit having a fluid entrance and a fluid exit separate from the fluid entrance;
positioning a screen in relationship to the conduit such that contaminants in the fluid are removed as the fluid passes through the screen; and
providing a cleaning mechanism operatively associated with the screen to remove contaminants from the screen;
wherein the fluid flow generates turbine motion causing rotation of at least one of the screen or the cleaning mechanism.

11. The method of claim 10, wherein the contaminants are removed from the screen by of at least one of the screen or the cleaning mechanism by a back flush using pressurize air, by a back flush using stored energy, or by combinations thereof.

12. The method of claim 10, wherein the screen is affixed to a shaft, the shaft also being operatively associated at a second end with a turbine head and a plurality of turbine blades attached to the head, wherein the turbine head is affixed downstream of the screen.

13. The method of claim 12, wherein the screen is positioned in at least one of the following:
i. the fluid entrance of the conduit so that the fluid passes through the screen before driving the turbine blades; or
ii. the fluid exit of the conduit so that the fluid is driving the turbine blades before passing through the screen.

14. The method of claim 10, wherein the screen is positioned in at least one of:
i. on top of the conduit for elevating the screen from a sediment bed; or
ii. within the conduit for extending the screen below a sediment bed.

15. The method of claim 12, wherein the cleaning mechanism is at least one of:
i. the screen rotating against or in operative relationship to the stationary turbine blades,
ii. the turbine blades rotating against a stationary screen,
iii. the turbine blades and the turbine motion positioned on the same side of the screen, and
iv. the turbine blades and the turbine motion positioned on opposite sides of the screen.

16. The method of claim 12, wherein a first end of the shaft is operatively associated with at least one of:
i. a knife-edge structure extended to cover a horizontal and vertical outward portion of the screen;
ii. a plurality of turbine blades positioned above a horizontal outward portion of the screen; and
iii. a brush-like structure extended to cover a horizontal and vertical inward portion of the screen.

17. The method of claim 10, wherein the screen is a corrugated screen comprising corrugated patterns located on:
i. a vertical surface of the screen;
ii. a horizontal surface of the; and
iii. a vertical surface and a horizontal surface of the screen.

18. A self-cleaning screen system for removal of contaminants from a fluid passed through a screen comprising:
a conduit;
a screen positioned in relationship to the conduit such that contaminants in the fluid are removed as the fluid passes through the screen; and
a cleaning mechanism in contact with the screen to remove contaminants, the system configured such that energy extracted from the fluid passing though the screen is used to rotate at least one of the screen or the cleaning mechanism and the rotation is caused by a turbine motion, a back flush using pressurized air or a back flush using stored energy, and combinations thereof.

19. The system of claim 18, wherein the screen is affixed to a shaft, the shaft being operatively associated at a second end with a turbine head and a plurality of turbine blades attached to the head, and wherein the turbine head is affixed downstream of the screen.

20. The system of claim 18, wherein the screen is a corrugated screen comprising corrugated patterns located on:
i. a vertical surface of the screen;
ii. a horizontal surface of the; and
iii. a vertical surface and a horizontal surface of the screen.
